(19) United States
(12) Patent Application Publication
(10) Pub. No.: US 2015/0039978 A1
(43) Pub. Date: Feb. 5, 2015

(54) Systems and Methods for Hybrid Priority Based Data Processing

(71) Applicant: LSI Corporation, San Jose, CA (US)

(72) Inventors: Kaitlyn T. Nguyen, San Jose, CA (US); Fan Zhang, Milpitas, CA (US); Jun Xiao, Fremont, CA (US)

(73) Assignee: LSI Corporation, San Jose, CA (US)

(21) Appl. No.: 13/954,573

(22) Filed: Jul. 30, 2013

(51) Int. Cl. G06F 11/10

(52) U.S. Cl. CPC G06F 11/10
USPC 714/819

(57) ABSTRACT

The present inventions are related to systems and methods for data processing, and more particularly to systems and methods for priority based data processing.

### BACKGROUND OF THE INVENTION

The present inventions are related to systems and methods for data processing, and more particularly to systems and methods for priority based data processing.

Various data transfer systems have been developed including storage systems, cellular telephone systems, radio transmission systems. In each of the systems data is transferred from a sender to a receiver via some medium. For example, in a storage system, data is sent from a sender (i.e., a write function) to a receiver (i.e., a read function) via a storage medium. In some cases, the data processing function uses a variable number of iterations through a data detector circuit and/or data decoder circuit depending upon the characteristics of the data being processed. Each data set is given equal priority until a given data set concludes either without errors in which case it is reporter, or concludes with errors in which case a retry condition may be triggered. In such a situation processing latency is generally predictable, but is often unacceptably large.

Hence, for at least the aforementioned reasons, there exists a need in the art for advanced systems and methods for data processing.

### BRIEF SUMMARY OF THE INVENTION

The present inventions are related to systems and methods for data processing, and more particularly to systems and methods for priority based data processing.

Various embodiments of the present invention provide data processing systems that include, inter alia, an input buffer, a data detector circuit, a data decoder circuit, a memory, and a selection circuit. The input buffer is operable to maintain at least a first data set and a second data set. The data detector circuit is operable to apply a data detection algorithm to a selected data set to yield a detected output. The data decoder circuit is operable to apply a data decode algorithm to a decoder input derived from the detected output to yield a decoded output. The memory is operable to store instances of a detector input derived from respective instances of the decoded output where one or more instances of the detector input correspond to the first data set or the second data set. The selection circuit is operable to: select one of the first data set or the second data set as the selected data set for application of the data detection algorithm based on a first in, first out algorithm where the selected data set has not yet been processed by the data detector circuit, and it is determined that no instances of the detector input is available in the memory for use in applying the data detection algorithm; and select one of the first data set or the second data set as the selected data set for application of the data detection algorithm where the selected data set has previously been processed by the data detector circuit, and it is determined that the instance of the detector input corresponding to the selected data set exhibits the highest quality of the instances of the detector input available in the memory.

This summary provides only a general outline of some embodiments of the invention. The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phases do not necessarily refer to the same embodiment. Many other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 shows a storage system including hybrid priority based scheduling circuitry in accordance with various embodiments of the present invention;

FIG. 2 depicts a data transmission system including hybrid priority based scheduling circuitry in accordance with one or more embodiments of the present invention;

FIG. 3 shows a data processing circuit including hybrid priority scheduler circuitry in accordance with some embodiments of the present invention; and

FIGS. 4a-4b are flow diagrams showing a method for hybrid priority based data processing in accordance with some embodiments of the present invention.

### DETAILED DESCRIPTION OF THE INVENTION

The present inventions are related to systems and methods for data processing, and more particularly to systems and methods for priority based data processing.

Various embodiments of the present invention provide for data processing that includes application of both a data detection algorithm and a data decode algorithm. Application of a series of the data detection algorithm and one or more instances of the data decode algorithm is referred to herein as a “global iteration”. During each global iteration one or more instances of the data detection algorithm may be applied. Application of the one or more instances of the data decode algorithm is referred to herein as a “local iteration”. In the embodiments, an input buffer holds data sets received for processing, and a central buffer holds data sets transitioning back and forth between application of the data detection algorithm and application of the data decode algorithm. Some embodiments of the present invention process data sets from the input buffer on their initial global iteration based upon a first in, first out priority. Data sets with a presence in the central buffer (i.e., those that have completed at least one global iteration), are selected for processing based upon a decode quality metric. The decode quality metric may be, for example, a number of unsatisfied checks remaining at the end of applying the data decode algorithm. Such an approach assures that each data set in the input buffer is given some opportunity to be processed and thus avoids input buffer jamming where data sets must be kicked out of the data processing system before they are given any chance, but still provides for quality based prioritization (based upon the decode quality metric) to assure that data sets that have a greater chance of successful convergence.

Various embodiments of the present invention provide data processing systems that include, inter alia, an input buffer, a data detector circuit, a data decoder circuit, a memory, and a selection circuit. The input buffer is operable to maintain at least a first data set and a second data set. The data detector circuit is operable to apply a data detection algorithm to a selected data set to yield a detected output. The data decoder circuit is operable to apply a data decode algorithm to a decoder input derived from the detected output to yield a decoded output. The memory is operable to store instances of a detector input derived from respective instances of the decoded output where one or more instances of the detector input correspond to the first data set or the second data set. The selection circuit is operable to: select one of the first data set or the second data set as the selected data set for application of the data detection algorithm based on a first in, first out algorithm where the selected data set has not yet been processed by the data detector circuit, and it is determined that no instances of the detector input is available in the memory for use in applying the data detection algorithm; and select one of the first data set or the second data set as the selected data set for application of the data detection algorithm where the selected data set has previously been processed by the data detector circuit, and it is determined that the instance of the detector input corresponding to the selected data set exhibits the highest quality of the instances of the detector input available in the memory.

In some instances of the aforementioned embodiments, the quality of the instances of the detector input is indicated by a quality metric. In such instances, the data processing system may further include a quality based priority scheduler circuit operable to determine which of the instances of the detector input corresponds to the quality metric indicating the highest quality. In some cases, the quality metric is the is the number of errors remaining after application of the data decode algorithm. The errors may be, for example, unsatisfied parity equations.

In various instances of the aforementioned embodiments, the processing systems further includes a time stamp circuit operable to provide an indicator of when the first data set is stored in the input buffer relative to when the second data set is stored in the input buffer.

Other embodiments of the present invention provide methods for data processing that include: storing a first data set to an input buffer; storing a second data set to the input buffer; applying a data detection algorithm using a data detector circuit to a selected data set to yield a detected output; applying a data decode algorithm using a data decoder circuit to a decoder input derived from the detected output to yield a decoded output; storing instances of a detector input derived from respective instances of the decoded output where one or more instances of the detector input correspond to the first data set or the second data set; selecting one of the first data set or the second data set as the selected data set for application of the data detection algorithm based on a first in, first out algorithm where the selected data set has not yet been processed by the data detector circuit, and it is determined that no instances of the detector input is available in the memory for use in applying the data detection algorithm; and selecting one of the first data set or the second data set as the selected data set for application of the data detection algorithm where the selected data set has previously been processed by the data detector circuit, and it is determined that the instance of the detector input corresponding to the selected data set exhibits the highest quality of the instances of the detector input available in the memory.

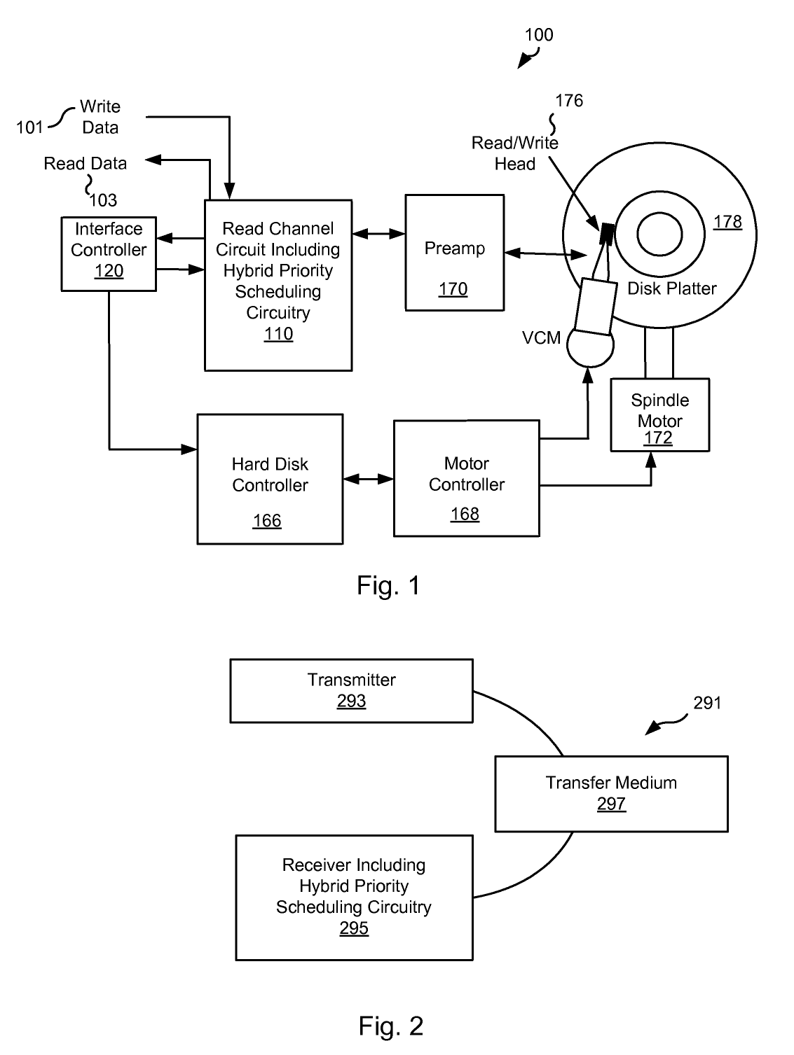

Turning to FIG. 1, a storage system 100 including a read channel circuit 110 having hybrid priority based scheduling circuitry is shown in accordance with various embodiments of the present invention. Storage system 100 may be, for example, a hard disk drive. Storage system 100 also includes a preamplifier 170, an interface controller 120, a hard disk controller 166, a motor controller 168, a spindle motor 172, a disk platter 178, and a read/write head 176. Interface controller 120 controls addressing and timing of data to/from disk platter 178. The data on disk platter 178 consists of groups of magnetic signals that may be detected by read/write head assembly 176 when the assembly is properly positioned over disk platter 178. In one embodiment, disk platter 178 includes magnetic signals recorded in accordance with either a longitudinal or a perpendicular recording scheme.

In a typical read operation, read/write head assembly 176 is accurately positioned by motor controller 168 over a desired data track on disk platter 178. Motor controller 168 both positions read/write head assembly 176 in relation to disk platter 178 and drives spindle motor 172 by moving read/write head assembly to the proper data track on disk platter 178 under the direction of hard disk controller 166. Spindle motor 172 spins disk platter 178 at a determined spin rate (RPMs). Once read/write head assembly 176 is positioned adjacent the proper data track, magnetic signals representing data on disk platter 178 are sensed by read/write head assembly 176 as disk platter 178 is rotated by spindle motor 172. The sensed magnetic signals are provided as a continuous, minute analog signal representative of the magnetic data on disk platter 178. This minute analog signal is transferred from read/write head assembly 176 to read channel circuit 110 via preamplifier 170. Preamplifier 170 is operable to amplify the minute analog signals accessed from disk platter 178. In turn, read channel circuit 110 decodes and digitizes the received analog signal to recreate the information originally written to disk platter 178. This data is provided as read data 103 to a receiving circuit. A write operation is substantially the opposite of the preceding read operation with write data 101 being provided to read channel circuit 110. This data is then encoded and written to disk platter 178.

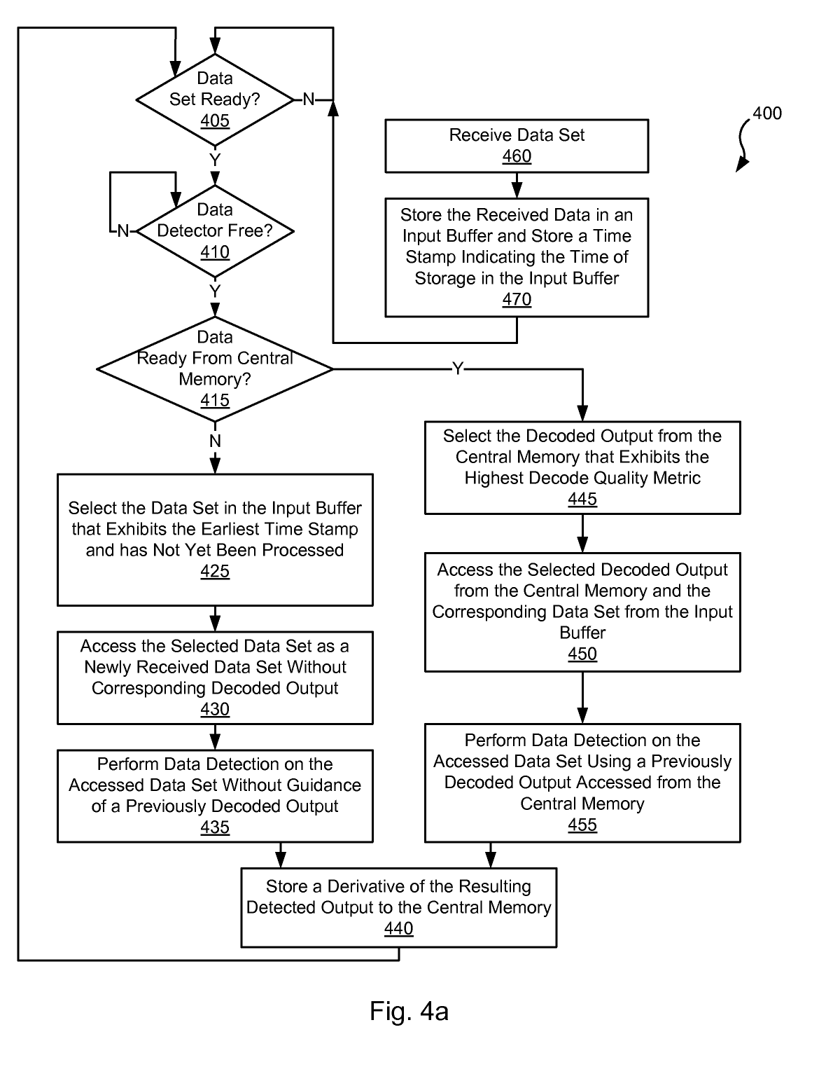

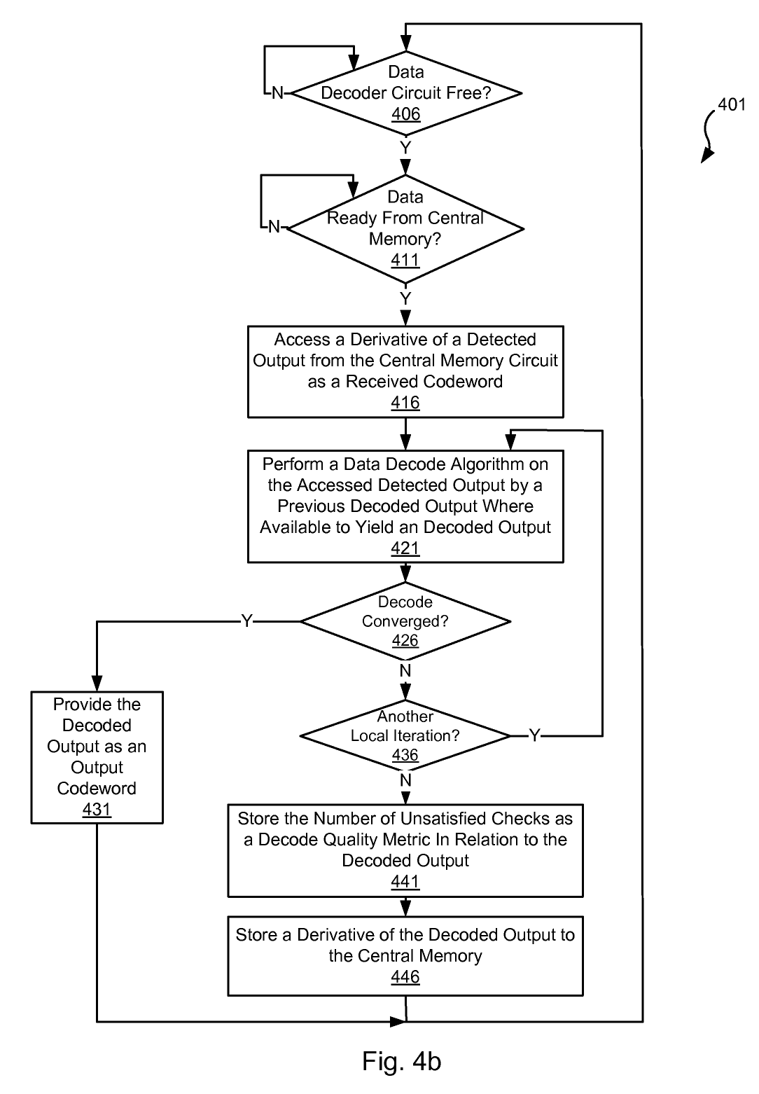

As part of processing the received information, read channel circuit 110 utilizes hybrid scheduling with first in first out scheduling to the data detector circuit for the first global iteration of any data set, and use a decode quality metric for scheduling data sets for the decoder and for the second and later iterations. This type of scheduling operations to prioritize application of processing cycles to higher quality codewords over lower quality codewords, but to assure that codewords are given an opportunity to process by using first in first out access for the first global iteration. In some cases, read channel circuit 110 may be implemented to include a data processing circuit similar to that discussed below in relation to FIG. 3. Further, the prioritizing of codeword processing may be accomplished consistent with one of the approaches discussed below in relation to FIGS. 4a-4b.

It should be noted that storage system 100 may be integrated into a larger storage system such as, for example, a RAID (redundant array of inexpensive disks or redundant array of independent disks) based storage system. Such a RAID storage system increases stability and reliability through redundancy, combining multiple disks as a logical unit. Data may be spread across a number of disks included in the RAID storage system according to a variety of algorithms and accessed by an operating system as if it were a single disk. For example, data may be mirrored to multiple disks in the RAID storage system, or may be sliced and distributed across multiple disks in a number of techniques. If a small number of disks in the RAID storage system fail or become unavailable, error correction techniques may be used to recreate the missing data based on the remaining portions of the data from the other disks in the RAID storage system. The disks in the RAID storage system may be, but are not limited to, individual storage systems such as storage system 100, and may be located in close proximity to each other or distributed more widely for increased security. In a write operation, write data is provided to a controller, which stores the write data across the disks, for example by mirroring or by striping the write data. In a read operation, the controller retrieves the data from the disks. The controller then yields the resulting read data as if the RAID storage system were a single disk.

A data decoder circuit used in relation to read channel circuit 110 may be, but is not limited to, a low density parity check (LDPC) decoder circuit as are known in the art. Such low density parity check technology is applicable to transmission of information over virtually any channel or storage of information on virtually any media. Transmission applications include, but are not limited to, optical fiber, radio frequency channels, wired or wireless local area networks, digital subscriber line technologies, wireless cellular, Ethernet over any medium such as copper or optical fiber, cable channels such as cable television, and Earth-satellite communications. Storage applications include, but are not limited to, hard disk drives, compact disks, digital video disks, magnetic tapes and memory devices such as DRAM, NAND flash, NOR flash, other non-volatile memories and solid state drives.

In addition, it should be noted that storage system 100 may be modified to include solid state memory that is used to store data in addition to the storage offered by disk platter 178. This solid state memory may be used in parallel to disk platter 178 to provide additional storage. In such a case, the solid state memory receives and provides information directly to read channel circuit 110. Alternatively, the solid state memory may be used as a cache where it offers faster access time than that offered by disk platted 178. In such a case, the solid state memory may be disposed between interface controller 120 and read channel circuit 110 where it operates as a pass through to disk platter 178 when requested data is not available in the solid state memory or when the solid state memory does not have sufficient storage to hold a newly written data set. Based upon the disclosure provided herein, one of ordinary skill in the art will recognize a variety of storage systems including both disk platter 178 and a solid state memory.

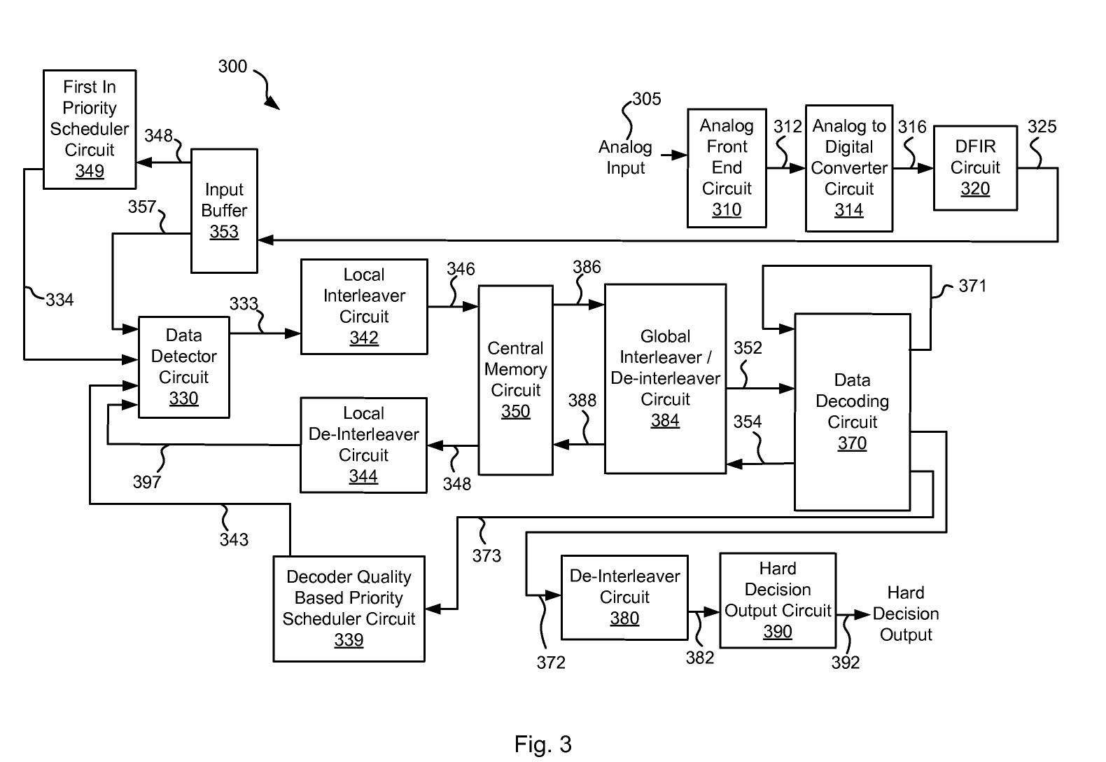

Turning to FIG. 2, a data transmission system 291 including a receiver 295 having hybrid priority based scheduling circuitry is shown in accordance with various embodiments of the present invention. Data transmission system 291 includes a transmitter 293 that is operable to transmit encoded information via a transfer medium 297 as is known in the art. The encoded data is received from transfer medium 297 by a receiver 295. Receiver 295 processes the received input to yield the originally transmitted data. As part of processing the received information, receiver 295 utilizes quality based priority scheduling circuitry that operates to prioritize application of processing cycles to higher quality codewords over lower quality codewords, based upon a decode quality metric, but to prioritize the initial processing of a codeword through a data detector circuit based upon a first in, first out prioritization. Such an approach operates to reduce latency of higher quality codewords and increases latency of lower quality codewords. Where higher quality codewords outnumber lower quality codewords, the average latency of all codewords is reduced. In some cases, receiver 295 may be implemented to include a data processing circuit similar to that discussed below in relation to FIG. 3. Further, the prioritizing of codeword processing may be accomplished consistent with one of the approaches discussed below in relation to FIGS. 4a-4b.

FIG. 3 shows a data processing circuit 300 including hybrid priority scheduler circuitry in accordance with some embodiments of the present invention. The hybrid priority based scheduler circuitry includes a first in priority scheduler circuit 349 operable to schedule data sets from an input buffer 353 for their first global iteration through a data detector circuit 330 and a data decoding circuit 370, and a decoder quality based priority scheduler circuit 339 operable to schedule data sets for their second and later global iterations.

Data processing circuit 300 includes an analog front end circuit 310 that receives an analog signal 305. Analog front end circuit 310 processes analog signal 305 and provides a processed analog signal 312 to an analog to digital converter circuit 314. Analog front end circuit 310 may include, but is not limited to, an analog filter and an amplifier circuit as are known in the art. Based upon the disclosure provided herein, one of ordinary skill in the art will recognize a variety of circuitry that may be included as part of analog front end circuit 310. In some cases, analog signal 305 is derived from a read/write head assembly (not shown) that is disposed in relation to a storage medium (not shown). In other cases, analog signal 305 is derived from a receiver circuit (not shown) that is operable to receive a signal from a transmission medium (not shown). The transmission medium may be wired or wireless. Based upon the disclosure provided herein, one of ordinary skill in the art will recognize a variety of source from which analog input 305 may be derived.

Analog to digital converter circuit 314 converts processed analog signal 312 into a corresponding series of digital samples 316. Analog to digital converter circuit 314 may be any circuit known in the art that is capable of producing digital samples corresponding to an analog input signal. Based upon the disclosure provided herein, one of ordinary skill in the art will recognize a variety of analog to digital converter circuits that may be used in relation to different embodiments of the present invention. Digital samples 316 are provided to an equalizer circuit 320. Equalizer circuit 320 applies an equalization algorithm to digital samples 316 to yield an equalized output 325. In some embodiments of the present invention, equalizer circuit 320 is a digital finite impulse response filter circuit as are known in the art. It may be possible that equalized output 325 may be received directly from a storage device in, for example, a solid state storage system. In such cases, analog front end circuit 310, analog to digital converter circuit 314 and equalizer circuit 320 may be eliminated where the data is received as a digital data input. Equalized output 325 is stored to input buffer 353 that includes sufficient memory to maintain one or more codewords until processing of that codeword is completed through data detector circuit 330 and data decoding circuit 370 including, where warranted, multiple global iterations (passes through both data detector circuit 330 and data decoding circuit 370) and/or local iterations (passes through data decoding circuit 370 during a given global iteration). An output 357 is provided to data detector circuit 330.

Data detector circuit 330 may be a single data detector circuit or may be two or more data detector circuits operating in parallel on different codewords. Whether it is a single data detector circuit or a number of data detector circuits operating in parallel, data detector circuit 330 is operable to apply a data detection algorithm to a received codeword or data set. In some embodiments of the present invention, data detector circuit 330 is a Viterbi algorithm data detector circuit as are known in the art. In other embodiments of the present invention, data detector circuit 330 is a is a maximum a posteriori data detector circuit as are known in the art. Of note, the general phrases “Viterbi data detection algorithm” or “Viterbi algorithm data detector circuit” are used in their broadest sense to mean any Viterbi detection algorithm or Viterbi algorithm detector circuit or variations thereof including, but not limited to, bi-direction Viterbi detection algorithm or bi-direction Viterbi algorithm detector circuit. Also, the general phrases “maximum a posteriori data detection algorithm” or “maximum a posteriori data detector circuit” are used in their broadest sense to mean any maximum a posteriori detection algorithm or detector circuit or variations thereof including, but not limited to, simplified maximum a posteriori data detection algorithm and a max-log maximum a posteriori data detection algorithm, or corresponding detector circuits. Based upon the disclosure provided herein, one of ordinary skill in the art will recognize a variety of data detector circuits that may be used in relation to different embodiments of the present invention. In some cases, one data detector circuit included in data detector circuit 330 is used to apply the data detection algorithm to the received codeword for a first global iteration applied to the received codeword, and another data detector circuit included in data detector circuit 330 is operable apply the data detection algorithm to the received codeword guided by a decoded output accessed from a central memory circuit 350 (i.e., a central buffer) on subsequent global iterations.

Upon completion of application of the data detection algorithm to the received codeword on the first global iteration, data detector circuit 330 provides a detector output 333. Detector output 333 includes soft data. As used herein, the phrase “soft data” is used in its broadest sense to mean reliability data with each instance of the reliability data indicating a likelihood that a corresponding bit position or group of bit positions has been correctly detected. In some embodiments of the present invention, the soft data or reliability data is log likelihood ratio data as is known in the art. Detected output 333 is provided to a local interleaver circuit 342. Local interleaver circuit 342 is operable to shuffle sub-portions (i.e., local chunks) of the data set included as detected output and provides an interleaved codeword 346 that is stored to central memory circuit 350. Interleaver circuit 342 may be any circuit known in the art that is capable of shuffling data sets to yield a re-arranged data set. Interleaved codeword 346 is stored to central memory circuit 350.

Once a data decoding circuit 370 is available, a previously stored interleaved codeword 346 is accessed from central memory circuit 350 as a stored codeword 386 and globally interleaved by a global interleaver/de-interleaver circuit 384. Global interleaver/De-interleaver circuit 384 may be any circuit known in the art that is capable of globally rearranging codewords. Global interleaver/De-interleaver circuit 384 provides a decoder input 352 into data decoding circuit 370. In some embodiments of the present invention, the data decode algorithm is a low density parity check algorithm as are known in the art. Based upon the disclosure provided herein, one of ordinary skill in the art will recognize other decode algorithms that may be used in relation to different embodiments of the present invention. Data decoding circuit 370 applies a data decode algorithm to decoder input 352 to yield a decoded output 371. In cases where another local iteration (i.e., another pass trough data decoder circuit 370) is desired, data decoding circuit 370 re-applies the data decode algorithm to decoder input 352 guided by decoded output 371. This continues until either a maximum number of local iterations is exceeded or decoded output 371 converges.

Where decoded output 371 fails to converge (i.e., fails to yield the originally written data set) and a number of local iterations through data decoder circuit 370 exceeds a threshold, the resulting decoded output is provided as a decoded output 354 back to central memory circuit 350 where it is stored awaiting another global iteration through a data detector circuit included in data detector circuit 330. Prior to storage of decoded output 354 to central memory circuit 350, decoded output 354 is globally de-interleaved to yield a globally de-interleaved output 388 that is stored to central memory circuit 350. The global de-interleaving reverses the global interleaving earlier applied to stored codeword 386 to yield decoder input 352. When a data detector circuit included in data detector circuit 330 becomes available, a previously stored de-interleaved output 388 accessed from central memory circuit 350 and locally de-interleaved by a de-interleaver circuit 344. De-interleaver circuit 344 re-arranges decoder output 348 to reverse the shuffling originally performed by interleaver circuit 342. A resulting de-interleaved output 397 is provided to data detector circuit 330 where it is used to guide subsequent detection of a corresponding data set previously received as equalized output 325.

Alternatively, where the decoded output converges (i.e., yields the originally written data set), the resulting decoded output is provided as an output codeword 372 to a de-interleaver circuit 380. De-interleaver circuit 380 rearranges the data to reverse both the global and local interleaving applied to the data to yield a de-interleaved output 382. De-interleaved output 382 is provided to a hard decision output circuit 390. Hard decision output circuit 390 is operable to re-order data sets that may complete out of order back into their original order. The originally ordered data sets are then provided as a hard decision output 392.

As equalized output 325 is being stored to input buffer 353, first in priority scheduler circuit 349 is provided an identifier 348 of the instance of equalized output and maintains a time stamp corresponding to the instance. Based upon the time stamp, first in priority scheduler circuit 349 provides a first iteration selector signal 334 to data detector circuit 330. When there are no data sets in input buffer 353 that have corresponding decoded outputs in central memory circuit 350 awaiting a second or later global iteration, data detector circuit 330 selects the data set in input buffer 353 indicated by first iteration selector signal 334 (i.e., the oldest received instance of equalized output 325) to begin its first global iteration.

Once the local iterations through data decoding circuit 370 are completed, a number of unsatisfied checks remaining (i.e., the number of parity equations that could not be satisfied by the decoding algorithm) or errors in the codeword are reported by data decoding circuit 370 to decoder quality based priority scheduler circuit 339 as a decode quality metric 373. The higher the number reported as decode quality metric 373 indicates a lower quality. Decoder quality based priority scheduler circuit 339 indicates the data set in central memory circuit 350 that exhibits the highest decode quality as a later iteration selector signal 343. When there are data sets in input buffer 353 that have corresponding decoded outputs in central memory circuit 350 awaiting a second or later global iteration, data detector circuit 330 selects the data set in input buffer 353 indicated by later iteration selector signal 343 (i.e., the highest quality data set) to begin a second or later global iteration guided by the corresponding data set from central memory circuit 350.

FIG. 4a is a flow diagram 400 showing a method for q hybrid priority based data processing in accordance with some embodiments of the present invention. Following flow diagram 400 a data set is received (block 460). This data set may be received, for example, from a storage medium or a communication medium. As the data set is received, it is stored to an input buffer (block 470). As the data set is stored to the input buffer, a time stamp is associated with the data set indicating an order in which the data set was received relative to other data sets in the input buffer.

It is repeatedly determined whether a data set is ready for processing (block 405). A data set may become ready for processing where either the data set was previously processed and a data decode has completed in relation to the data set and the respective decoded output is available in a central memory, or where a previously unprocessed data set becomes available in the input buffer. Where a data set is ready (block 405), it is determined whether a data detector circuit is available to process the data set (block 410).

Where the data detector circuit is available for processing (block 410), it is determined whether there is a decoded output in the central memory that is ready for additional processing (block 415). Where there is not a decoded output in the central memory (block 415), the oldest data set (i.e., the data set with the earliest time stamp) in the input buffer is selected (block 425). In some cases, only one previously unprocessed data set is available in the input buffer. In such cases, the only available data set is selected. The selected data set is accessed from the input buffer (block 430) and a data detection algorithm is applied to the newly received data set (i.e., the first global iteration of the data set) without guidance of a previously decoded output (block 435). In some cases, the data detection algorithm is a Viterbi algorithm data detector circuit or a maximum a posteriori data detector circuit. Application of the data detection algorithm yields a detected output. A derivative of the detected output is stored to the central memory (block 440). The derivative of the detected output may be, for example, an interleaved or shuffled version of the detected output.

Alternatively, where a decoded output is available in the central memory and ready for additional processing (bock 415), the available decoded output in the central memory that exhibits the highest quality is selected (block 445). The highest quality is the decoded output that corresponds to a decode quality metric (see block 441) with the lowest value. In some cases, only one decoded output is available in the central memory. In such cases, the only available decoded output is selected. The data set corresponding to the selected decoded output is accessed from the input buffer and the selected decoded output is accessed from the central memory (block 450), and a data detection algorithm is applied to the data set (i.e., the second or later global iteration of the data set) using the accessed decoded output as guidance (block 455). Application of the data detection algorithm yields a detected output. A derivative of the detected output is stored to the central memory (block 440). The derivative of the detected output may be, for example, an interleaved or shuffled version of the detected output.

Turning to FIG. 4b, a flow diagram 401 shows a counterpart of the method described above in relation to FIG. 4a. Following flow diagram 401, in parallel to the previously described data detection process of FIG. 4a, it is determined whether a data decoder circuit is available (block 406). The data decoder circuit may be, for example, a low density data decoder circuit as are known in the art. Where the data decoder circuit is available (block 406), it is determined whether a derivative of a detected output is available for processing in the central memory (block 411). Where such a data set is ready (block 411), the previously stored derivative of a detected output is accessed from the central memory and used as a received codeword (block 416). A data decode algorithm is applied to the received codeword to yield a decoded output (block 421). Where a previous local iteration has been performed on the received codeword, the results of the previous local iteration (i.e., a previous decoded output) are used to guide application of the decode algorithm. It is then determined whether the decoded output converged (i.e., resulted in the originally written data) (block 426). Where the decoded output converged (block 426), it is provided as an output codeword (block 431). Alternatively, where the decoded output failed to converge (block 426), it is determined whether another local iteration is desired (block 436). In some cases, four local iterations are allowed per each global iteration. Based upon the disclosure provided herein, one of ordinary skill in the art will recognize another number of local iterations that may be used in relation to different embodiments of the present invention. Where another local iteration is desired (block 436), the processes of blocks 406-436 are repeated for the codeword. Alternatively, where another local iteration is not desired (block 436), the number of unsatisfied checks are stored as the decode quality metric in relation to the decoded output (block 441), and a derivative of the decoded output is stored to the central memory (block 446). The derivative of the decoded output being stored to the central memory triggers the data set ready query of block 405 to begin the data detection process.

In some embodiments of the present invention during the aforementioned data decoding and data detection processing described above in relation to FIG. 4a, the clock provided to one or both of the data detection circuit or the data decoding circuit is generated in accordance with the method described in a flow diagram 451 of FIG. 4b. Following flow diagram 451, it is determined whether the data decoding circuit is operational (block 450). The data decoding circuit is considered operational when it is actively applying a data decode algorithm to a data set. Where the data decoding circuit is operational (block 450), it is determined whether the data detector circuit is operational (block 455). The data detector circuit is considered operational when it is actively applying a data decode algorithm to a data set. Where it is determined that the data detector circuit is operational (block 455) a clock count is incremented (block 460). The clock count modulus N is then determined, and where the clock count modulus N is equal to zero (block 465), the current cycle of one or both of a clock synchronizing operation of the data detector circuit and/or a clock synchronizing operation of the data decoding circuit is deleted or suppressed (block 470).

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In conclusion, the invention provides novel systems, devices, methods and arrangements for priority based data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A data processing system, the data processing system comprising:
an input buffer operable to maintain at least a first data set and a second data set;
a data detector circuit operable to apply a data detection algorithm to a selected data set to yield a detected output;
a data decoder circuit operable to apply a data decode algorithm to a decoder input derived from the detected output to yield a decoded output;
a memory operable to store instances of a detector input derived from respective instances of the decoded output, wherein one or more instances of the detector input correspond to the first data set or the second data set; and
a selection circuit operable to:
select one of the first data set or the second data set as the selected data set for application of the data detection algorithm based on a first in, first out algorithm where the selected data set has not yet been processed by the data detector circuit, and it is determined that no instances of the detector input is available in the memory for use in applying the data detection algorithm; and
select one of the first data set or the second data set as the selected data set for application of the data detection algorithm where the selected data set has previously been processed by the data detector circuit, and it is determined that the instance of the detector input corresponding to the selected data set exhibits the highest quality of the instances of the detector input available in the memory.

2. The data processing system of claim 1, wherein the quality of the instances of the detector input is indicated by a quality metric, and wherein the data processing system further comprises:
a quality based priority scheduler circuit operable to determine which of the instances of the detector input corresponds to the quality metric indicating the highest quality.

3. The data processing system of claim 2, wherein the quality metric is the number of errors remaining after application of the data decode algorithm.

4. The data processing system of claim 3, wherein the errors are unsatisfied parity equations.

5. The data processing system of claim 1, wherein the processing system further comprises:
a time stamp circuit operable to provide an indicator of when the first data set is stored in the input buffer relative to when the second data set is stored in the input buffer.

6. The data processing system of claim 1, wherein the data detector circuit is selected from a group consisting of: a Viterbi algorithm data detector circuit, and a maximum a posteriori data detector circuit.

7. The data processing system of claim 1, wherein the data decoder circuit is a low density parity check decoder circuit.

8. The data processing system of claim 1, wherein the system is implemented as an integrated circuit.

9. The data processing system of claim 1, wherein the system is implemented as a storage device, and wherein the storage device further comprises:
a storage medium;
a head assembly disposed in relation to the storage medium and operable to provide a sensed signal corresponding to information on the storage medium; and
a read channel circuit including:
an analog to digital converter circuit operable to sample an analog signal derived from the sensed signal to yield a series of digital samples; and
an equalizer circuit operable to equalize the digital samples to yield the first data set and the second data set.

10. A method for data processing, the method comprising:
storing a first data set to an input buffer;
storing a second data set to the input buffer;
applying a data detection algorithm using a data detector circuit to a selected data set to yield a detected output;
applying a data decode algorithm using a data decoder circuit to a decoder input derived from the detected output to yield a decoded output;
storing instances of a detector input derived from respective instances of the decoded output, wherein one or more instances of the detector input correspond to the first data set or the second data set;
selecting one of the first data set or the second data set as the selected data set for application of the data detection algorithm based on a first in, first out algorithm where the selected data set has not yet been processed by the data detector circuit, and it is determined that no instances of the detector input is available in the memory for use in applying the data detection algorithm; and
selecting one of the first data set or the second data set as the selected data set for application of the data detection algorithm where the selected data set has previously been processed by the data detector circuit, and it is determined that the instance of the detector input corresponding to the selected data set exhibits the highest quality of the instances of the detector input available in the memory.

11. The method of claim 10, wherein the quality of the instances of the detector input is indicated by a quality metric, and wherein the method further comprises:
determining which of the instances of the detector input corresponds to the quality metric indicating the highest quality.

12. The method of claim 11, wherein the quality metric is the number of errors remaining after application of the data decode algorithm.

13. The method of claim 12, wherein the errors are unsatisfied parity equations.

14. The method of claim 10, wherein the method further includes:
time stamping the first data set and the second data set to indicate when the first data set is stored in the input buffer relative to when the second data set is stored in the input buffer.

15. The method of claim 10, wherein the data detector circuit is selected from a group consisting of: a Viterbi algorithm data detector circuit, and a maximum a posteriori data detector circuit.

16. The method of claim 10, wherein the data decoder circuit is a low density parity check decoder circuit.

17. A storage device, the storage device comprising:
a storage medium;
a head assembly disposed in relation to the storage medium and operable to provide a sensed signal corresponding to information on the storage medium;
a read channel circuit including:
an analog to digital converter circuit operable to sample an analog signal derived from the sensed signal to yield a series of digital samples;
an equalizer circuit operable to equalize the digital samples to yield a first data set and a second data set;
an input buffer operable to maintain at least a first data set and a second data set;
a data detector circuit operable to apply a data detection algorithm to a selected data set to yield a detected output;
a data decoder circuit operable to apply a data decode algorithm to a decoder input derived from the detected output to yield a decoded output;
a memory operable to store instances of a detector input derived from respective instances of the decoded output, wherein one or more instances of the detector input correspond to the first data set or the second data set; and
a selection circuit operable to:
select one of the first data set or the second data set as the selected data set for application of the data detection algorithm based on a first in, first out algorithm where the selected data set has not yet been processed by the data detector circuit, and it is determined that no instances of the detector input is available in the memory for use in applying the data detection algorithm; and
select one of the first data set or the second data set as the selected data set for application of the data detection algorithm where the selected data set has previously been processed by the data detector circuit, and it is determined that the instance of the detector input corresponding to the selected data set exhibits the highest quality of the instances of the detector input available in the memory.

18. The storage device of claim 17, wherein the quality of the instances of the detector input is indicated by a quality metric, and wherein the data processing system further comprises:
a quality based priority scheduler circuit operable to determine which of the instances of the detector input corresponds to the quality metric indicating the highest quality.

19. The storage device of claim 18, wherein the quality metric is the number of errors remaining after application of the data decode algorithm.

20. The storage device of claim 19, wherein the errors are unsatisfied parity equations.
